(19) United States
(12) Patent Application Publication
(10) Pub. No.: US 2011/0184983 A1
(43) Pub. Date: Jul. 28, 2011

(54) METHOD AND SYSTEM FOR EXTRACTING AND CHARACTERIZING RELATIONSHIPS BETWEEN ENTITIES MENTIONED IN DOCUMENTS

(75) Inventors: Peter J. KWANTES, Mississauga (CA); Philip G. TER HAAR, Brampton (CA)

(73) Assignees: HER MAJESTY THE QUEEN IN RIGHT OF CANADA AS REPRESENTED BY THE MINISTER; OF THE DEPARTMENT OF NATIONAL DEFENCE, Ottawa (CA)

(21) Appl. No.: 13/015,088

(22) Filed: Jan. 27, 2011

Related U.S. Application Data
(60) Provisional application No. 61/299,041, filed on Jan. 28, 2010.

(51) Int. Cl. G06F 17/30

(52) U.S. Cl. 707/776; 707/E17.045

(57) ABSTRACT

Methods and devices for use in gathering and analyzing data from a corpus of documents. A corpus of documents is initially scanned for words that qualify as entities according to user defined criteria. Multiple counters track the number of documents which mention specific entities. A database of entities mentioned in the documents is maintained and an entry for each entity in the corpus is placed in the entity database. The results are then presented to a user in a spiral form with the most important entity at the center of the spiral. The importance of an entity may be determined by either how many entities it is connected to or how many documents mention that entity. A connection exists between two entities if they are both mentioned in at least one document and the more documents mention two specific entities at the same time, the stronger the connection between those two specific entities. The result presentation to the user is capable of also visually representing connections between entities by connecting connected entities with lines. The strength of a connection can also be represented with the width of the line connecting two entities.

### RELATED APPLICATIONS

The present application claims the benefit of priority of U.S. Provisional Patent Application No. 61/299,041 filed 28 Jan. 2010, which is hereby incorporated by reference.

### FIELD OF THE INVENTION

The present invention relates to the analysis of data. More specifically, the present invention relates to systems and methods which are useful for analyzing data derived from a corpus of documents with the data relating to connections and relationships between entities mentioned in the documents.

### BACKGROUND OF THE INVENTION

The task of the intelligence analyst is an unenviable one. Regardless of whether the intelligence sought is economic, political, military, or gossip-oriented, the task remains the same: deriving useful intelligence data from available sources and collating that data into a meaningful result.

Most analysts (whether they are working for intelligence agencies, the military, or marketing firms, or media) rely on documents, reports, and even stories available from the publicly available media. To this end, intelligence analysts need to read and review hundreds if not thousands of documents. While reading these documents, analysts have to rely on notes, memory, and other means to map out relationships, contexts, and entities mentioned in these documents. Clearly, this is a Herculean task.

It would greatly assist an analyst if connections between entities in a situation being analyzed could be mapped out. Similarly, knowledge of the strength of such connections would be useful for analysts. Finally, the nature and context of the connection between entities in that situation should also be extremely helpful to the analyst. Normally, as noted above, the intelligence analyst would need to read and digest volumes of documents to obtain the necessary background information to derive the context, strength, and nature of connections between entities.

To this end, some work has been performed in assisting with the derivation of useful data from documents. Communications between individuals is one of the best sources of information and a study was made in 2004 that analyzed the communications between people within strictly defined confines such as the company Enron (McCallum, A., Corrada-Emmanuel, A., and Wang, X. (2004). The Author-Recipient-Topic Model for Topic and Role Discovery in Social Networks: Experiments with Enron and Academic Email. Technical Report UM-CS-2004-096, 2004.) However, this study did not include an analysis of the content of the communications but merely the author-recipient and topic of the communications.

To date, there does not seem to be any tools available that would assist the analyst in the tasks mentioned above. There is therefore a need for tools that can, preferably, automate some of the tasks mentioned above and hopefully alleviate the workload for analysts.

### SUMMARY OF INVENTION

The present invention relates to methods and devices for use in gathering and analyzing data from a corpus of documents. A corpus of documents is initially scanned for words that qualify as entities according to user defined criteria. The frequency with which entities occur in each document in the corpus is stored in a database, from which information about the co-occurrence of entities in said documents can be derived.

The results are then presented to a user in a spiral form with the most important entity at the center of the spiral. The importance of an entity may be determined by either how many entities it is connected to or how many documents mention that entity. A connection exists between two entities if they are both mentioned in at least one document and the more documents mention two specific entities at the same time, the stronger the connection between those two specific entities. The result presentation to the user is capable of also visually representing connections between entities by connecting connected entities with lines. The strength of a connection can also be represented with the width of the line connecting two entities.

In a first aspect, the present invention provides a method of extracting data from a plurality of documents, said method being for use in determining relationships between entities mentioned in said documents, the method comprising:

a) receiving a plurality of documents from a database
b) for each document received, performing the following steps:
b1) determining which entities are mentioned in said document
b2) incrementing a counter for each entity mentioned in said document
b3) determining which entities are mentioned together in said document
b4) creating an entity entry in an entity database for each entity mentioned in said document and for which there is no entity entry in said entity database
   c) presenting results to a user, a presentation representation to said user comprising arranging representations of said entities mentioned in said documents in a spiral by order of importance with a most important entity being placed at a center of said spiral.

In another aspect, the present invention provides a system for extracting data from a plurality of documents, said comprising:
a document reception module for receiving documents from a database
a document scanner module for scanning a specific document retrieved from said database
a lookup module for determining if a specific word in said specific document is a mention of a specific entity
a presentation module for presenting results obtained by said tracking module to said user, said presentation module arranging entities mentioned in said documents in a spiral form with entities increasingly important entities being placed closer to a center of said spiral.

### BRIEF DESCRIPTION OF THE DRAWINGS

The invention will be described with reference to the accompanying drawings, wherein

FIG. 1 is a screenshot of a presentation of results obtained by scanning a corpus of documents according to one aspect of the invention;

FIG. 2 is a screenshot similar to FIG. 1 but where entities connected to other entities are illustrated as being attached by lines;

FIG. 2A is a screenshot similar to FIG. 2 showing entities which are mentioned in conjunction with other entities being connected lines with the thickness of the line denoting the strength of that connection;

FIG. 3 is a screenshot illustrating all the connections of two entities with connections for one entity being denoted by lines of one color and connections for the other entity being denoted by lines of a different color;

FIG. 3A is a screenshot illustrating the result after a spiral presentation has been stretched and manipulated to allow the user to view occluded entity labels;

FIG. 4 is a screenshot of a user interface which allows users to view documents which mention specific entities together;

FIG. 5 is a screenshot of a user interface which allows users to customize keywords to be used with specific concepts;

FIG. 6 is a screenshot of a spiral graph illustrating the various entities which are connected to a specific entity and which are also connected by a specific concept;

FIG. 7 is a block diagram of a system according to one aspect of the invention;

FIG. 8 is a flowchart illustrating the steps in a method which may be used when scanning each document.

### DETAILED DESCRIPTION OF THE INVENTION

In a general aspect of the invention, a software system receives or retrieves a corpus of documents to be scanned for derivable data. The contents of each document in the corpus are scanned for words that conform to predetermined criteria for identifying entities. Each word found in the document that conforms to the criteria for an entity is tracked. This may be done by creating for each entity a corresponding entry in a database of entities as well as a counter to track how many documents mention that entity. This may also be done by using an array and a series of linked lists that, again, tracks how many documents mention each entity. Any entity found in the document which already has an entry in the entity database or in the array/linked list system will have its counter incremented for every document that refers to that entity. An entry in the database is also created for each document, each document entry noting the document number as well as which entities are mentioned in that document.

From the above, it should be clear that if a document mentions entities A, B, and C, then counters for those entities are created and these counters are incremented. Similarly, if entities A and B already have existing counters, then their counters are incremented while for entity C, its counter is created.

In one implementation, a word is determined to conform to the entity criteria if the first letter for that word is capitalized. To ensure that common articles and common words are not mistakenly identified as entities, a database of “non-entities” or “stop-words” which will never be considered as entities (e.g. “The”, “I”, “He”, “She”, etc.) may be used. Other means to reduce the instances of false positives for entities may be used.

Once each document has been scanned for entities mentioned in the document, all combinations of entities mentioned in the document are determined. For each combination either a counter for that combination is created and incremented or, if a counter for that combination already exists, that counter is incremented. These counters keep track of not only which entities are connected but also of the strength of that connection. A connection between two entities exists when at least one document mentions both entities. The counter for each combination keeps track of how many documents mention both entities in the combination and the larger the number of documents that mention both entities, the stronger the connection between these entities.

To track which documents mention which entities, a linked list is created for each document. Each entry in the linked list is an entity mentioned in that document. The linked lists for all the documents are then stored in an SQL database and, to determine which documents reference which entity or combination of entities, SQL queries to the SQL database can be made.

To keep track of concepts or topics that an entity may be associated with, another database may be created. This concept database may have separate categories/headings or topics to be tracked. Under each category or topic, the user may add various words that correspond to that topic. As an example, under the topic ROMANCE, the user may add the keywords “marriage”, “engagement”, “divorce”, “love”, “affair”, “dating”, or any other keywords associated with the concept of ROMANCE. Similarly, under the topic RELIGION, the user may add the keywords “church”, “mosque”, “Catholic”, “Muslim”, “born-again”, “religion”, “worship”, “faith”, and others that relate to the concept of RELIGION.

Queries regarding concepts and the entities or documents which mention them can be made by using latent semantic analysis (LSA). For reference to LSA, the following documents (which are hereby incorporated by reference herein) may be consulted:
Landauer, T. K., Foltz, P. W., & Laham, D. (1998), Introduction to Latent Semantic Analysis. Discourse Processes, 25, 259-284.
U.S. Pat. No. 4,839,853.

Other documents which may be consulted for LSA are as follows:
Deerwester, S., Dumais, S. T., Landauer, T. K., Furnas, G. W. and Harshman, R. A. (1990)—no figures, “Indexing by latent semantic analysis.” Journal of the Society for Information Science, 41(6), 391-407.
Dumais, S. T., Furnas, G. W., Landauer, T. K. and Deerwester, S. (1988), “Using latent semantic analysis to improve information retrieval.” In Proceedings of CHI'88: Conference on Human Factors in Computing, New York: ACM, 281-285.
Dumais, S. T. (1991), “Improving the retrieval of information from external sources.” Behavior Research Methods, Instruments and Computers, 23(2), 229-236.
Dumais, S. T. and Schmitt, D. G. (1991), “Iterative searching in an online database.” In Proceedings of Human Factors Society 35th Annual Meeting, 398-402.
Dumais, S. T. and Nielsen, J. (1992), “Automating the assignment of submitted manuscripts to reviewers.” In N. Belkin, P. Ingwersen, and A. M. Pejtersen (Eds.), SIGIR'92: Proceedings of the 15th Annual International ACM SIGIR Conference on Research and Development in Information Retrieval. ACM Press, pp. 233-244.
Foltz, P. W. and Dumais, S. T. (1992)—html, “Personalized information delivery: An analysis of information filtering methods.” Communications of the ACM, 35(12), 51-60.
Dumais, S. T. (1993), “LSI meets TREC: A status report.” In: D. Harman (Ed.), The First Text REtrieval Conference (TREC1), National Institute of Standards and Technology Special Publication 500-207, pp. 137-152.
Dumais, S. T. (1994), “Latent Semantic Indexing (LSI) and TREC-2.” In: D. Harman (Ed.), The Second Text REtrieval Conference (TREC2), National Institute of Standards and Technology Special Publication 500-215, pp. 105-116.
Dumais, S. T. (1995), “Using LSI for information filtering: TREC-3 experiments.” In: D. Harman (Ed.), The Third Text REtrieval Conference (TREC3) National Institute of Standards and Technology Special Publication, in press 1995.
Berry, M. W., Dumais, S. T., and O'Brien, G. W. (1995). “Using linear algebra for intelligent information retrieval.” SIAM Review, 37(4), 1995, 573-595.
Caid, W. R., Dumais, S. T. and Gallant, S. I. (1995), “Learned vector space models for information retrieval.” Information Processing and Management, 31(3), 419-429.
Dumais, S. T. (1996), “Combining evidence for effective information filtering.” In AAAI Spring Symposium on Machine Learning and Information Retrieval, Tech Report SS-96-07, AAAI Press, March 1996.
Rosenstein, M. and Lochbaum, C. (2000) “Recommending from Content: Preliminary Results from an E-Commerce Experiment.” In Proceedings of CHI'00: Conference on Human Factors in Computing, The Hague, The Netherlands: ACM.
Chen, C., Stoffel, N., Post, N., Basu, C., Bassu, D. and Behrens, C. (2001) “Telcordia LSI Engine: Implementation and Scalability Issues.” In Proceedings of the 11th Int. Workshop on Research Issues in Data Engineering (RIDE 2001): Document Management for Data Intensive Business and Scientific Applications, Heidelberg, Germany, Apr. 1-2, 2001.
Bassu, D. and Behrens, C. (2003) “Distributed LSI: Scalable Concept-based Information Retrieval with High Semantic Resolution.” In Proceedings of the 3rd SIAM International Conference on Data Mining (Text Mining Workshop), San Francisco, Calif., May 3, 2003.
Landauer, T. K. and Littman, M. L. (1990) “Fully automatic cross-language document retrieval using latent semantic indexing.” In Proceedings of the Sixth Annual Conference of the UW Centre for the New Oxford English Dictionary and Text Research, pp. 31-38. UW Centre for the New OED and Text Research, Waterloo Ontario, October 1990.
Dumais, S. T., Landauer, T. K. and Littman, M. L. (1996) “Automatic cross-linguistic information retrieval using Latent Semantic Indexing.” In SIGIR'96—Workshop on Cross-Linguistic Information Retrieval, pp. 16-23, August 1996.
Dumais, S. T., Letsche, T. A., Littman, M. L. and Landauer, T. K. (1997) “Automatic cross-language retrieval using Latent Semantic Indexing.” In AAAI Spring Symposuim on Cross-Language Text and Speech Retrieval, March 1997.
M. L. Littman, and G. A. Keim (1997) “Cross-language text retrieval with three Languages”. Submitted to NIPS'97.
Wittenburg, K. and Sigman, E. “Integration of Browsing, Searching, and Filtering in an Applet for Web Information Access.” CHI'97 Modeling Human Memory.
Landauer, T. K. and Dumais, S. T. (1977) “Solution to Plato's Problem: The Latent Semantic Analysis Theory of Acquisition, Induction and Representation of Knowledge.” Psychological Review, 1997, 104 (2), 211-240.
Dumais, S. T. (1997) “Using LSI for Information Retrieval, Information Filtering, and Other Things”. Talk at Cognitive Technology Workshop, Apr. 4-5, 1997.
“Computer information retrieval using latent semantic structure”. U.S. Pat. No. 4,839,853, Jun. 13, 1989.
“Computerized cross-language document retrieval using latent semantic indexing”. U.S. Pat. No. 5,301,109, Apr. 5, 1994.

To use LSA, after the scanning of each document for entities as mentioned above, semantic representations of each document are then created. This is done by:
a) creating a matrix containing the frequency with which each unique word (i.e. words carrying semantic information and therefore not articles such as “the” or “and”) occurs across all the documents in the corpus. For this matrix, each row would correspond to a word and each column would correspond to a document. The intersection of each column and row would contain the number of occurrences for that particular word in that particular document. It should be noted that this is done for each word carrying semantic information and not just for proper nouns;
b) Transforming each cell by taking the natural logarithm of each frequency, and then weighing each cell by a word's distribution across documents using Shannon's entropy metric;
c) apply Singular Value Decomposition (SVD) on the matrix to reduce the dimensionality of each word's vector; and
d) When the original matrix is reconstructed using only the top 50-1000 singular values, each word's vector in the newly re-constructed (Term)×(Document) matrix is now a semantic representation of that word from the corpus. A vector representation for a particular document not appearing in the model's training corpus can therefore by created by simply summing together all the vectors for the words found in that document.

Referring to step c) above, an explanation of Singular Value Decomposition may be found in these references (these references being hereby incorporated herein by reference):
Trefethen, Lloyd N.; Bau III, David (1997), Numerical linear algebra, Philadelphia: Society for Industrial and Applied Mathematics, ISBN 978-0-89871-361-9.
Demmel, James; Kahan, William (1990), “Accurate singular values of bidiagonal matrices”, Society for Industrial and Applied Mathematics. Journal on Scientific and Statistical Computing 11 (5): 873-912, doi:10.1137/0911052.
Golub, Gene H.; Kahan, William (1965), “Calculating the singular values and pseudo-inverse of a matrix”, Journal of the Society for Industrial and Applied Mathematics: Series B, Numerical Analysis 2 (2): 205-224, i:10.1137/0702016, http://www.jstor.org/stable/2949777.
Golub, Gene H.; Van Loan, Charles F. (1996), Matrix Computations (3rd ed.), Johns Hopkins, ISBN 978-0-8018-5414-9.
GSL Team (2007), “§13.4 Singular Value Decomposition”, GNU Scientific Library. Reference Manual.
Halldor, Bjornsson and Venegas, Silvia A. (1997). “A manual for EOF and SVD analyses of climate data”. McGill University, CCGCR Report No. 97-1, Montreal, Québec, 52 pp.
Hansen, P. C. (1987). The truncated SVD as a method for regularization. BIT, 27, 534-553.
Horn, Roger A. and Johnson, Charles R (1985). “Matrix Analysis”. Section 7.3. Cambridge University Press. ISBN 0-521-38632-2.
Horn, Roger A. and Johnson, Charles R (1991). Topics in Matrix Analysis, Chapter 3. Cambridge University Press. ISBN 0-521-46713-6.
Strang G (1998). “Introduction to Linear Algebra”. Section 6.7. 3rd ed., Wellesley-Cambridge Press. ISBN 0-9614088-5-5.
Stewart, G. W. (1993), “On the Early History of the Singular Value Decomposition”, SIAM Review 35 (4): 551-566, doi:10.1137/1035134, http://citeseer.ist.psu.edu/stewart92early.html.
Wall, Michael E., Andreas Rechtsteiner, Luis M. Rocha (2003). “Singular value decomposition and principal component analysis”. in A Practical Approach to Microarray Data Analysis. D. P. Berrar, W. Dubitzky, M. Granzow, eds. pp. 91-109, Kluwer: Norwell, Mass.

Once semantic representations of each document can be created (by adding the vectors of each word in the document), the nature of the connections between entities can be queried. As an example, if a user wanted to search for entities connected to entity A by the concept of ROMANCE, the user would have to create/define the concept of romance. This is done by the user by entering words which he or she would consider as indicative or defining of the concept of romance. Thus, words or terms such as “marriage”, “love”, “boyfriend”, “girlfriend”, “significant other”, and others would be entered by the user. Once the concept has been defined, the system would then retrieve the semantic vector for each of the words that were used to define the concept of “romance”. These semantic vectors are then summed together and the resulting vector is the semantic vector for the concept of “romance”. Then, the vector representation for each document that mentions entity A and at least one other entity is constructed and compared to the semantic vector for “romance” for similarity. If the similarity is at or above a certain threshold, then entity A and any other entity mentioned in that document are thus connected by the concept of “romance”. Of course, if the similarity between the semantic vector of the desired concept and the vector representation of the document is below the threshold then, for that document, entity A and the other entities in the document are not connected by that concept.

It should be noted that the term “similar” as applied to the above may use the concept of cosine similarity between the two semantic vectors being compared. Cosine similarity determines the cosine of the angle between the two vectors being compared. Other measures of similarity between two vectors may also be used.

Once the data has been gathered and collated from all of the documents in the corpus, the results are presented to the user based on the user's desired configuration.

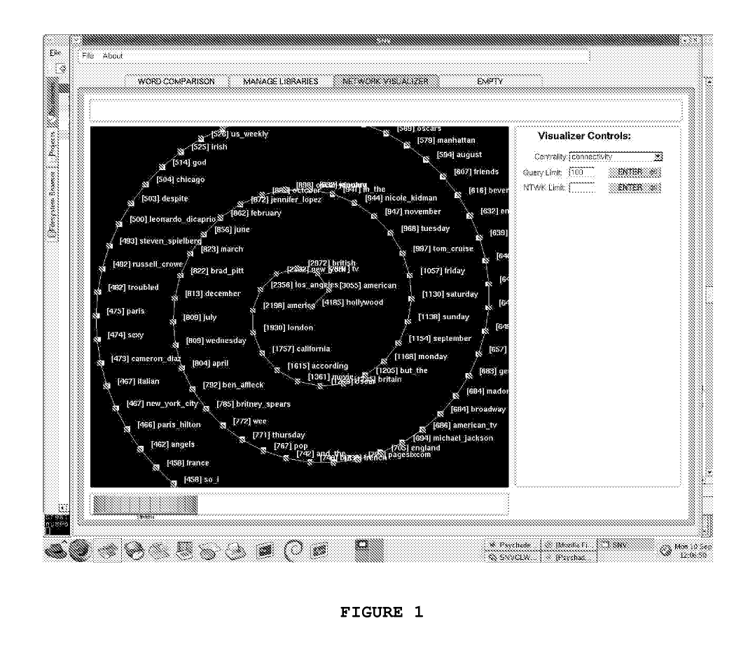

Referring to FIG. 1, a screenshot of the user interface is illustrated. As can be seen, the entities are arranged in a spiral with the most important entity being placed at the center of the spiral. The rest of the entities are arranged throughout the spiral in descending importance. Thus, if one traverses the spiral from the center, the most important entity is at the center of the spiral, followed by the 2nd most important entity, then the 3rd most important entity, and so on.

Relative importance of the entities can be determined either by the number of documents referencing each entity or by the number of connections each entity has.

Thus, depending on which option the user uses, the most important entity can be the entity which has been mentioned in the most documents or it can be the entity that has the most connections (i.e. the entity that is mentioned together with the most other entities). The entities can therefore be arranged depending on whether the user wishes to see the entity with the most connections or the entity most mentioned by the documents.

Referring to FIG. 1, a screenshot of a presentation of the results according to one aspect of the invention is illustrated. As can be seen, entities with most connections are closer to the center of the spiral. The entity mentioned with the most connections is listed as being America with 2198 connections. It should be noted that that spiral view can be expanded, stretched out, rotated, and/or manipulated. This provides the user with options so that overprinted labels and/or obscured labels can be viewed.

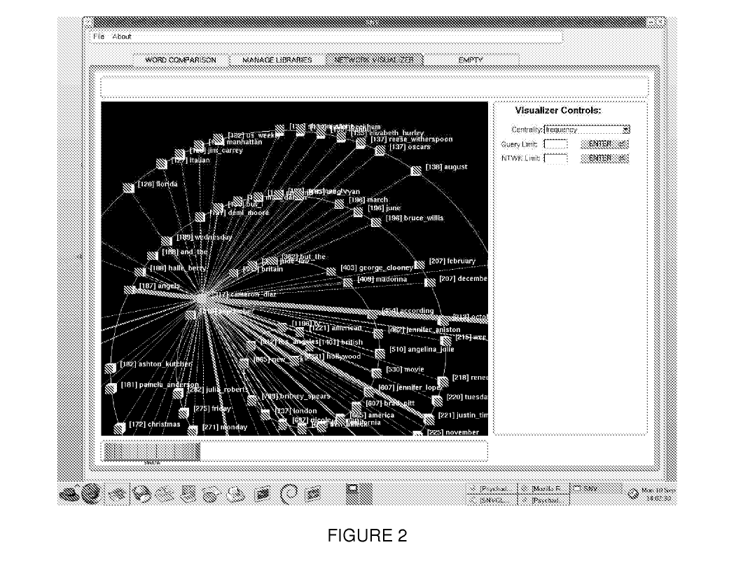

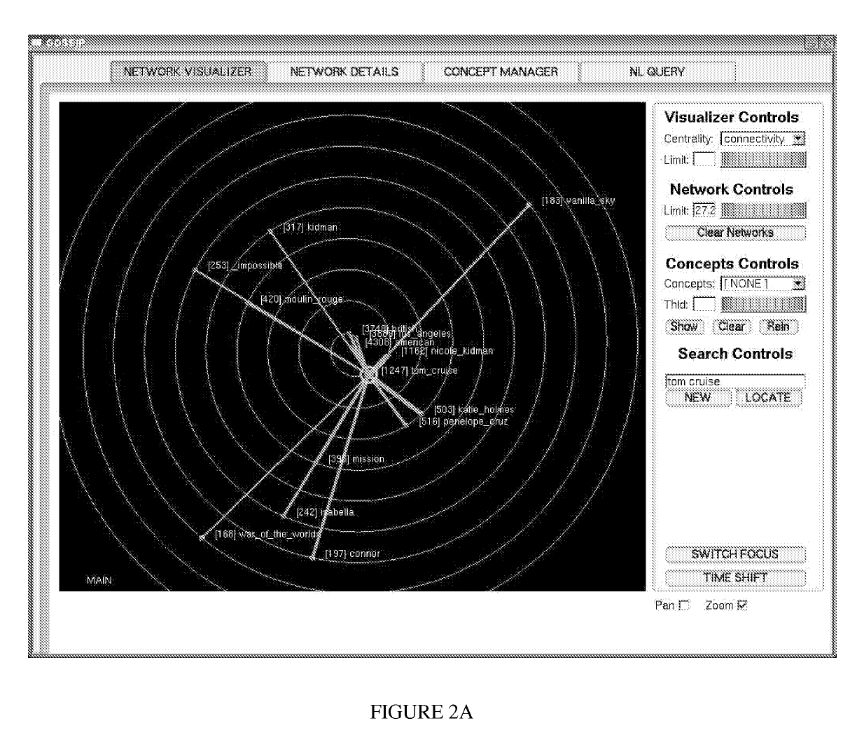

Referring to FIG. 2, a screenshot similar to FIG. 1 is illustrated. However, the screenshot in FIG. 2 is listed as being centered around the entity Cameron Diaz and illustrates her connections. The representation of the entity Cameron Diaz is connected by lines to other entities—the presence of a line between the entity Cameron Diaz and another entity means that Diaz and that other entity have been mentioned together in at least one document in the corpus. The thickness of the line connecting Cameron Diaz and another entity denotes the strength of that connection. The strength of a connection between two entities is determined by how many documents mention both entities in the same document. As an example, the connection between Cameron Diaz and the entity “angels” is quite strong as the line connecting them is thick and dark compared to the other lines in the presentation. Her connection to the entity Bruce Willis, on the other hand, is quite weak as the line is neither thick nor dark. This means that, while the connection is weak, there is possibly a connection as there should be at least one document that mentions both Cameron Diaz and Bruce Willis together.

Another example of such a presentation is shown in FIG. 2A which illustrates connections between the “Tom Cruise” entity and the other entities. The strength of these connections are shown by the thickness of the lines. As can be seen, the strongest connected entity to “Tom Cruise” is the entity “Katie Holmes” as the line connecting the two is the thickest. Other characteristics of the line (such as color, thickness, size, etc.) connecting connected entities can be used to document strength, quality, or any other characteristics of that connection. It should be noted that the corpus of documents used for this example is a collection of show business and entertainment news articles.

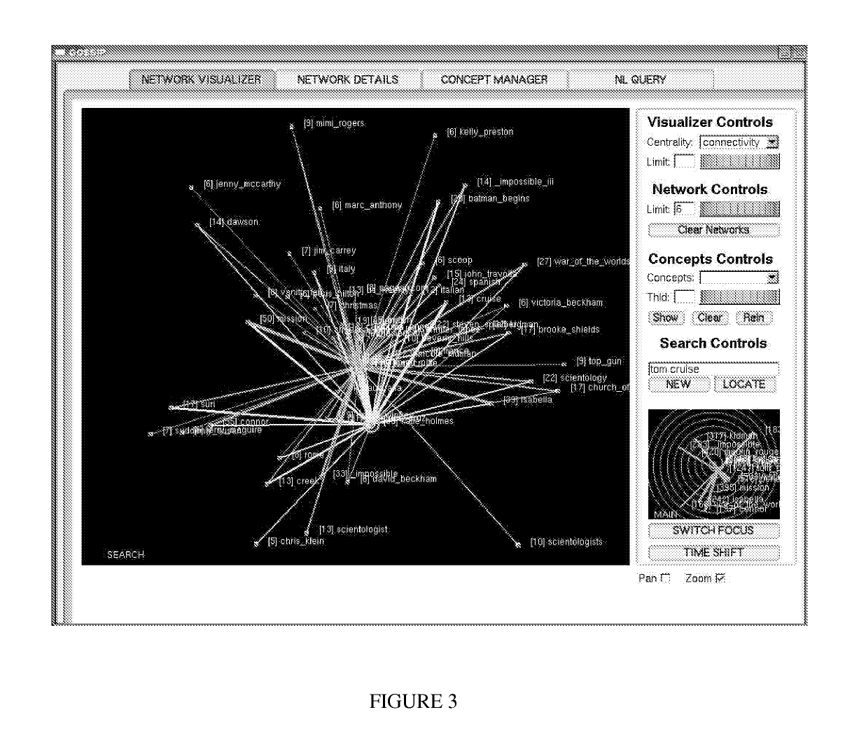

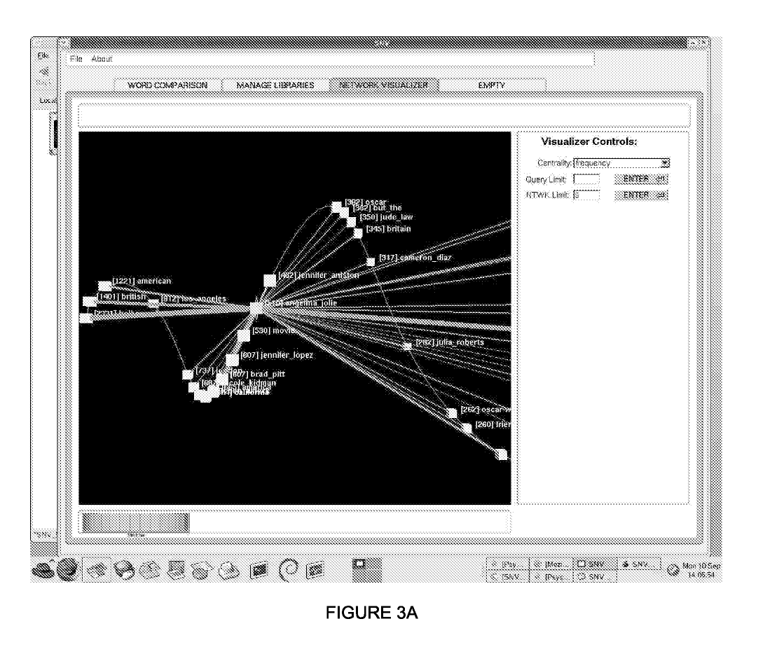

Referring to FIG. 3, a screenshot illustrates all of the connections that are shared between Tom Cruise and Katie Holmes, regardless of topic. The different colors refer to which selected entity the connections belong to—Tom or Katie. Using the thickness of the lines we can see, of Tom and Katie's connections, what other entities are more or less connected to either Tom or Katie.

It should be noted that, to further assist in the viewability of the different results, the user can rotate the spiral about a number of various axes. As well, the spiral display can also be stretched along various axes to aid the user in viewing the results.

Occluded nodes can be zoomed into or revealed by rotating, stretching, or otherwise manipulating the spiral. FIG. 3A illustrates the end result of manipulating, moving and stretching, and uncoiling the spiral so that the various entity names can now be seen. FIG. 3A centers around the entity Angelina Jolie and, by stretching the spiral, the names of the entities she is connected to can be more clearly seen.

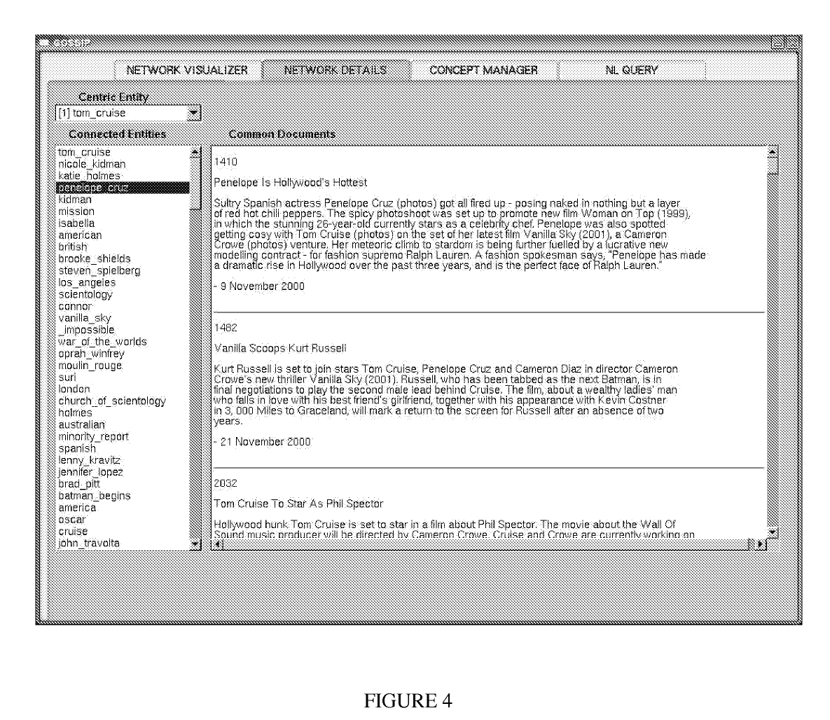

Referring to FIG. 4, a screenshot of a user interface for one aspect of the invention is illustrated. For this section, each entry in the document that connects two specific entities may be accessed by the user by simply searching for a central entity (in this example “Tom Cruise”) and then clicking on the other entity to whom the central entity is associated (in this example “Penelope Cruz”). By querying the database, the system can retrieve all the relevant documents that list both the central entity and one entity with whom that central entity is connected.

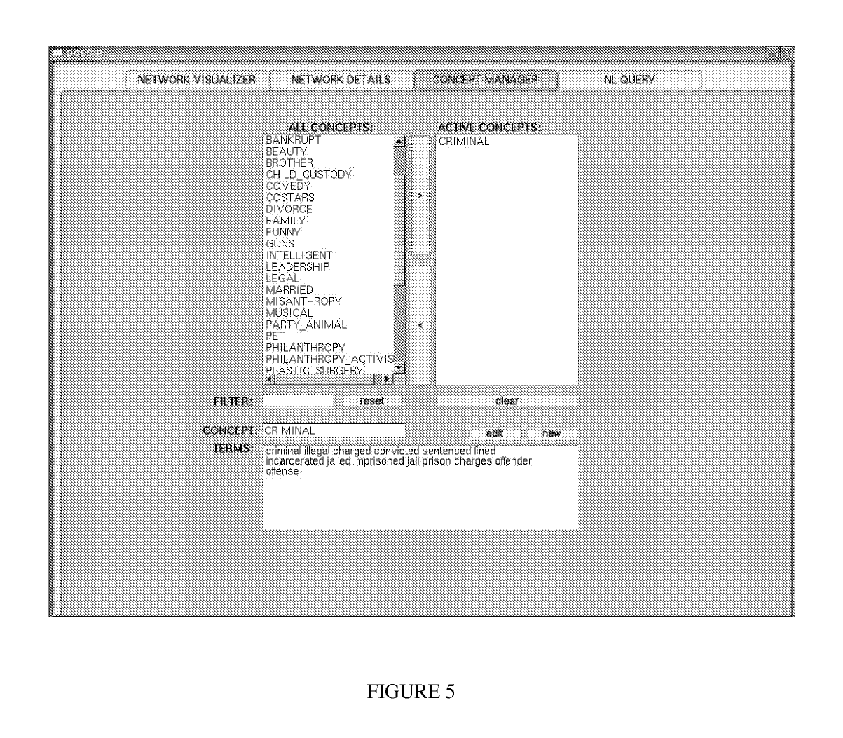

Referring to FIG. 5, a screenshot of a user interface for the user-definable keywords for the various concepts or topics is illustrated. As can be seen, the user can create a specific concept or topic and the user can enter various keywords which are considered to be associated with that user-defined concept. By doing so, the user can create a semantic vector for that new concept or idea. The semantic vector is constructed by summing the LSA semantic vectors for the words that have been used to define the new concept or idea.

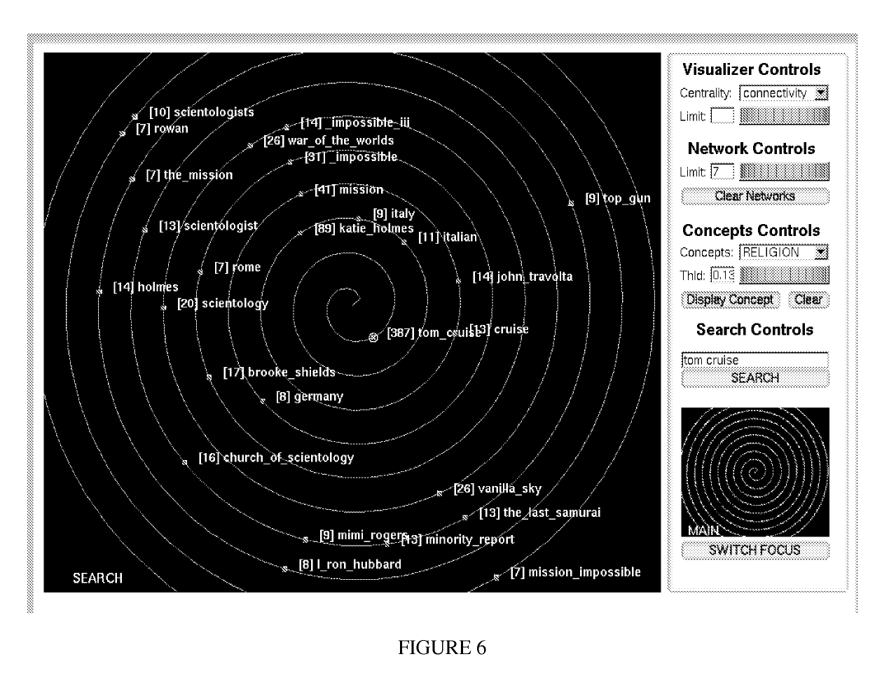

Referring to FIG. 6, a screenshot of another aspect of the invention is illustrated. The screenshot illustrates a spiral graph for the entities connected with the entity “Tom Cruise” by way of documents that discuss the entities with the “Tom Cruise” entity along with the concept of RELIGION, as that is defined from its keywords. The entities are again arranged in a spiral in the order of their overall importance (as defined by number of connections or the number of documents that mention the entity) in the document collection.

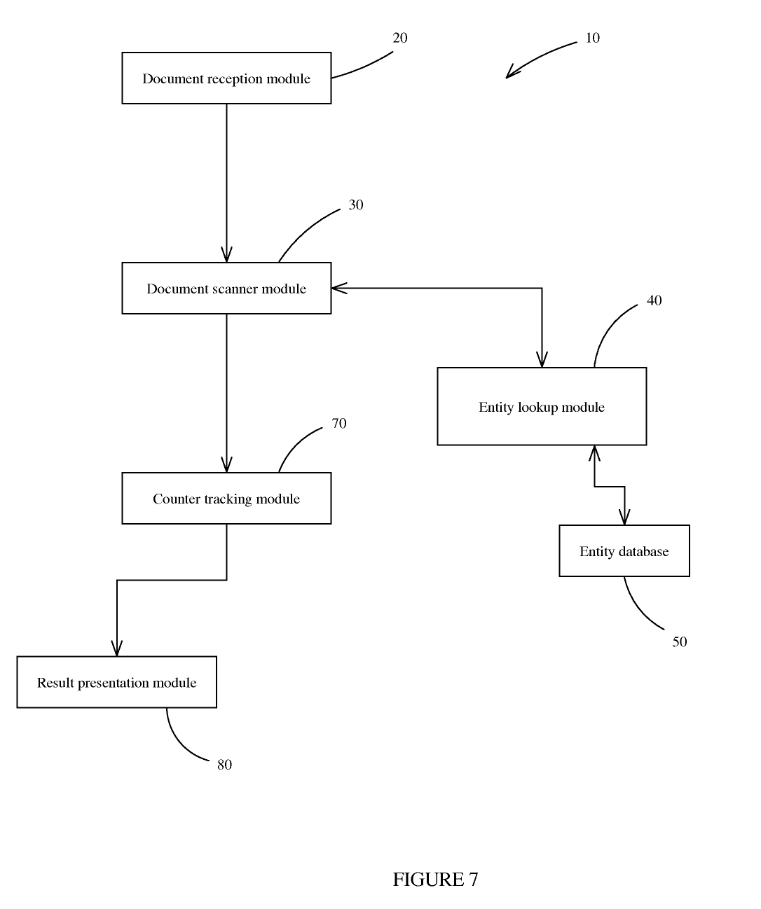

Referring to FIG. 7, a block diagram of the system according to another aspect of the invention is illustrated. The system 10 has document reception module 20 that receives documents from a document database (not shown) that contains the corpus of documents. Once a document has been received by the reception module 10, the document is then scanned word by word by the document scanner module 30. If the word encountered conforms to the criteria for a suitable entity and is not noted in the entity database 50 or in the array and linked list system mentioned above, the lookup module 40 then creates an entry in the entity database (or in the linked list and array system) and creates whatever counters are required.

It should be noted that, to account for various forms of names and various nicknames of entities, the entity database has, for each entity, various names which, when encountered, is counted as a hit for a specific entity. As an example, for the entity “Tom Cruise”, encountering “Mr. Cruise”, would count as a hit towards the “Tom Cruise” entity. Similarly, the entity “Bill Clinton” would receive hits whenever the terms “President Clinton”, “William Jefferson Clinton”, “Pres. Clinton”, “ex-President Clinton” are encountered. A user could also enter the various nicknames (whether flattering or derogatory) for entities to ensure that references to these entities are properly tracked. As such, a reference to “Governor Moonbeam” would reflect a count towards the entity “Jerry Brown” while a reference to “Dugout Doug” would reflect a count towards the entity “Douglas MacArthur”. Each occurrence of a nickname or alternative name for a specific entity is not treated as another instance of a new entity but is merely handled as another instance or mention of that specific entity. The system also allows a user to define various aliases/spellings to describe or define a single entity. Thus, a user may define an entity entry for Muammar Qadafi having multiple possible aliases or spellings for the same name. The entry for Muammar Qadafi can thus allow for Moammar Khadafy, Colonel Qadafi, or any other spellings of Col. Qadafi's name. This is especially useful for transliterated names or concepts such as the different spellings of “Taleban” or “Taliban”.

Once the scanner module 30 has finished scanning a specific document, a counter tracking module 70 then determines which entities are mentioned in that document and increments and/or creates counters for the various entities mentioned in the document. Each document entry in the database will thus have a document number as well as indications which denote which entities are mentioned in that document.

After all the relevant documents in corpus have been scanned and the relevant data has been derived from the documents, a result presentation module 80 then presents the results to the user. The presentation module 80 arranges the data in the manner requested by the user (e.g. whether the entities are arranged according to the number of connections or whether they are arranged according to the number of documents in which they are mentioned).

It should be noted that users may define a specific date range for the data and result retrieval. As an example, the user may define the search result to only be based on documents from a specific data range. Since the database already contains the data from all of the documents in the corpus, the search can merely skip over data that has been gathered from a document that is dated outside of the user defined range. This ability to date limit the data to be scanned allows the user to view any changes over time in relationships or in the importance of specific entities.

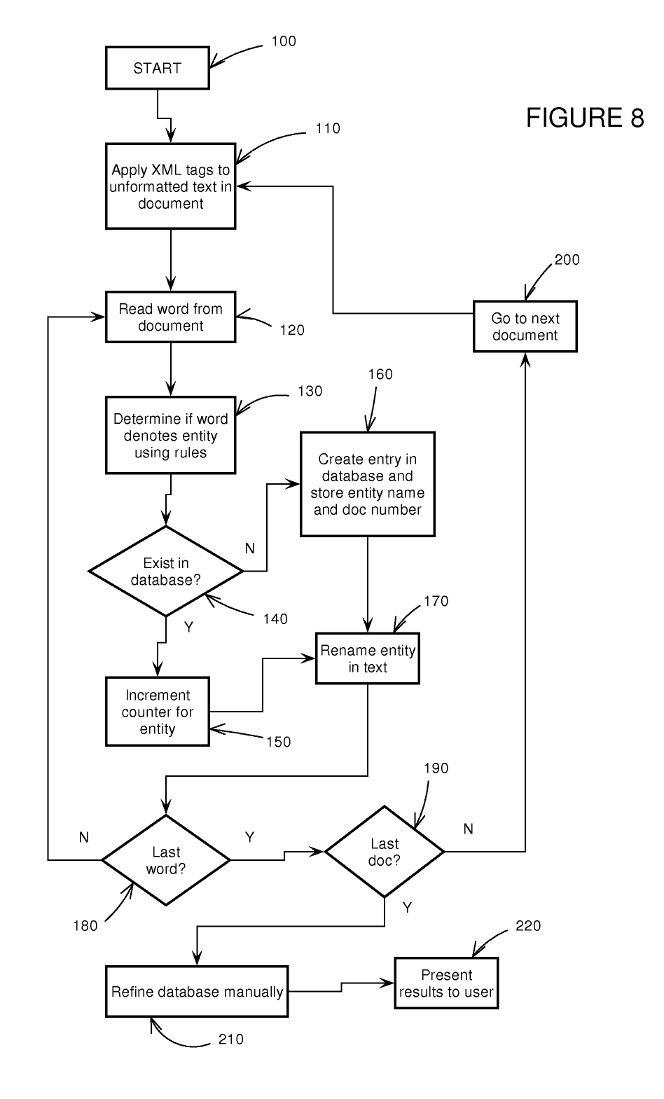

The method used to scan each document is illustrated in the flowchart of FIG. 8. After the start 100 of the method, step 110 is the application of XML tags to unformatted text in the document. The application of XML tags renders the document easier to automatically process. A word is then read from the document being scanned (step 120). Step 130 then checks to see if the word read denotes an entity using predefined entity determination rules (e.g. if the first letter of the word is capitalized, it could denote an entity). If the word read is an entity based on the entity determination rules (e.g. the word or word group is “Tom Cruise”) then step 140 decides if there is an entry for that entity in the entity database. If an entry exists for that entity in the entity database, then a counter for that entity is incremented and the database is updated to note the document number against the entity. If the entity has already been mentioned in this specific document, the counter is not incremented. Of course, as mentioned above, the entity counter tracks how many documents mention a specific entity. In the event the entity denoted by the word is not in the entity database, then step 160 creates an entity entry in the entity database and notes the document number against the newly created entity entry. By entering the document number of each document that mentions a specific entity against that entity's entry in the entity database, a listing of documents that mention an entity can easily be generated.

Once the entry in the database has been made, the entity in the document is replaced with the entity name in the database (step 170). This step is also executed after step 150. Thus, regardless of which name/entity name is mentioned in the documents, all instances of that entity is replaced with the same entity identifier. As an example, all references to President Clinton (whether they be William Jefferson Clinton, Bill Clinton, etc.) are replaced with the entity identifier President Clinton. This way, it is simpler to scan the documents for mentions of this specific entity.

After the instance of the entity in the document has been replaced, then step 180 checks if the word encountered is the last word in the document. If not, then the method loops to step 120 and another word is examined. If the word is the last word, then step 190 checks if the document being examined is the last document in the corpus. If not, then step 200 retrieves the next document and then the method loops back to step 110 for the new document. In the event the document is the last document in the corpus, then, in step 210 the user may manually edit the entity database to eliminate any entity redundancies. Of course, this may also be done automatically by comparing entries to ensure that clear redundancies are eliminated. Step 220 then presents the results of the data gathering to the user using the spiral presentation explained above.

It should be noted that, as explained above, user defined concepts can be created by selecting a number of words that define the user defined concept. A semantic representation for the user defined concept is created by summing the semantic vectors for the various words used to define the concept. This allows documents and entities to be filtered by user-defined concepts. As an example, a user can seek entities that are connected to, as an example, Tom Cruise, where the connection has something to do with a concept, for example RELIGION. This is accomplished by scanning several sets of documents with each set including documents that discuss Tom Cruise with person A, person B, person C, and so on. Thus, each set includes documents which connect Tom Cruise with a specific person, e.g. person A, person B, etc. For each set, all of the words in the documents are then summed and the resulting vector is compared to the semantic vector for the concept being sought (in this example, RELIGION). If the similarity between the vector for the concept and the vector for the set exceeds a defined threshold, then the entity discussed in the set with Tom Cruise is connected to him by the concept of RELIGION. The entity in the spiral graph with Tom Cruise is thus visible to indicate that Tom Cruise is connected to that entity by that concept.

Another way the user may filter the entities using a concept is to determine which entities have a semantic association with that concept. This is accomplished by comparing each entity's semantic vector with the semantic vector for that concept. If the similarity between the entity's semantic vector and the concept's semantic vector is above a certain threshold (either predefined or user determined), the it can be concluded that that entity is associated with the concept. The entity can thus be displayed on the screen with other entity's associated with that concept. Of course, in terms of relative importance, the higher the similarity between the semantic vector of an entity and the semantic vector of a concept, then the higher the relative importance of that entity when associated with the concept. As noted above, the more relatively important an entity is, the closer it is to the center of a spiral.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques).

The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method of extracting data from a plurality of documents, said method being for use in determining relationships between entities mentioned in said documents, the method comprising:
a) receiving a plurality of documents from a database
b) for each document received, performing the following steps:
b1) determining which entities are mentioned in said document
b2) incrementing a counter for each entity mentioned in said document
b3) determining which entities are mentioned together in said document
b4) creating an entity entry in an entity database for each entity mentioned in said document and for which there is no entity entry in said entity database
c) presenting results to a user, a presentation representation to said user comprising arranging representations of said entities mentioned in said documents in a spiral by order of increasing importance with a most important entity being placed at a center of said spiral.

2. A method according to claim 1 wherein importance is determined by a number of documents mentioning an entity with a most important entity being an entity mentioned in a greatest number of documents retrieved from said database in step a)

3. A method according to claim 1 wherein importance is determined by how many distinct entities are connected to a specific entity, and wherein a connection between two entities exists if both entities are mentioned together in at least one document.

4. A method according to claim 1 wherein said plurality of documents comprises documents from a time period specified by said user.

5. A method according to claim 3 wherein connections between entities are represented by a line drawn between representations of connected entities in step c).

6. A method according to claim 5 wherein characteristics of a line connecting representations of connected entities represent a strength of said connection.

7. A method according to claim 1 further including the step of determining which specific concepts are mentioned in said document, said specific concepts being based on semantic vectors of keywords.

8. A method according to claim 7 further including determining which specific concepts and which entities are mentioned together in said document.

9. A method according to claim 7 including the step of determining a closeness of association between specific entities based on semantic vectors of said specific concepts and said specific entities, said semantic vectors being derived from documents which mention said specific concepts and/or said specific entities.

10. A system for extracting data from a plurality of documents, said comprising:
a document reception module for receiving documents from a database
a document scanner module for scanning a specific document retrieved from said database
a lookup module for determining if a specific word in said specific document is a mention of a specific entity
a presentation module for presenting results obtained by said tracking module to said user, said presentation module arranging entities mentioned in said documents in a spiral form with entities increasingly important entities being placed closer to a center of said spiral.
